(19) United States
(12) Patent Application Publication
(10) Pub. No.: US 2013/0278178 A1
(43) Pub. Date: Oct. 24, 2013

(54) INDICATION CIRCUIT FOR SPEED OF LOCAL AREA NETWORK CONNETION

(71) Applicant: INGRASYS TECHNOLOGY INC., Taoyuan (TW)

(72) Inventor: CHUAN-TSAI HOU, Taoyuan (TW)

(73) Assignee: INGRASYS TECHNOLOGY INC., Taoyuan (TW)

(21) Appl. No.: 13/775,109

(22) Filed: Feb. 22, 2013

(30) Foreign Application Priority Data
Apr. 23, 2012 (TW) 101114384

(51) Int. Cl. H05B 37/02

(52) U.S. Cl. CPC H05B 37/02
USPC 315/313

(57) ABSTRACT

An indication circuit includes a network port, a detecting microchip, a first NOT AND (NAND) gate, a second NAND gate, a NOT gate, a first AND gate, and a second AND gate. The network port receives a network connector of a network cable therein, and includes a first light-emitting diode (LED) L1 and a second LED L2. The detecting microchip is electronically connected to the network port to detect a LAN speed, and accordingly output a group of logic control signal. The first NAND gate, the NOT gate, and the first AND gate are electronically connected between the first NAND gate and an anode of the first LED and a cathode of the second LED. The second NAND gate and the second AND gate are electronically connected between the first NAND gate and a cathode of the first LED and an anode of the second LED.

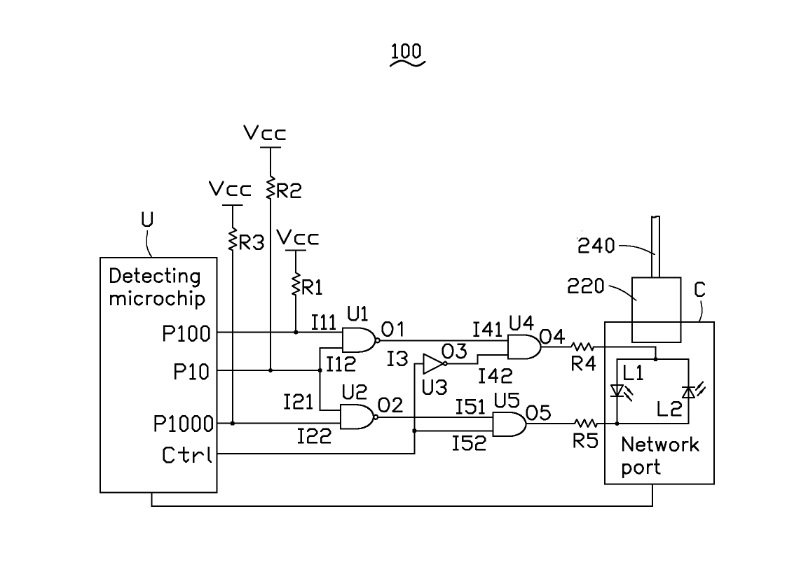

### BACKGROUND

1. Technical field

The disclosure generally relates to indication circuits, and particularly to an indication circuit for indicating speed of a local area network (LAN).

2. Description of the Related Art

LAN speeds can be 10 million bits per second (Mbps), 100 Mbps, or 1000 Mbps, for example. When a network connector is coupled to a network port of an electronic device, such as a server, a light-emitting diode (LED) of the network port will be lit to indicate the LAN speed. However, the network port may only include two LEDs for respectively indicating the LAN speed of 100 Mbps and 1000 Mbps, and not for any other LAN speed values.

Therefore, there is room for improvement within the art.

### BRIEF DESCRIPTION OF THE DRAWINGS

Many aspects of the present disclosure can be better understood with reference to the drawing. The components in the drawing are not necessarily drawn to scale, the emphasis instead being placed upon clearly illustrating the principles of the present embodiments.

The FIGURE is a circuit view of an indication circuit for LAN speeds, according to an exemplary embodiment.

### DETAILED DESCRIPTION

The FIGURE shows an indication circuit 100, which can be used in an electronic device, such as a personal computer. The indication circuit 100 is configured to indicate speed of a local area network (LAN). In one exemplary embodiment, the LAN speed can be 10 million bits per second (Mbps), 100 Mbps, or 1000 Mbps.

The indication circuit 100 includes a network port C, a detecting microchip U, three pull-up resistors R1, R2, and R3, a first NOT AND (NAND) gate U1, a second NAND gate U2, a NOT gate U3, a first AND gate U4, a second AND gate U5, and two current-limiting resistors R4, and R5.

The network port C is configured to receive a network connector 220 of a network cable 240. The network port C includes a first light-emitting diode (LED) L1 and a second LED L2.

The detecting microchip U is electronically connected to the network port C. When the network connector 220 is coupled to the network port C, the detecting microchip U can detect the LAN speed via the network cable 240. The detecting microchip U includes a first data pin P100, a second data pin P10, and a third data pin P1000. The first, second, and third data pins P100, P10, and P1000 are electronically connected to a power supply VCC via the three pull-up resistors R1, R2, and R3, respectively. The detecting microchip U is configured to set logic levels (logic “0” or “1”) for the first, second, and third data pins P100, P10, and P1000. Specifically, if the LAN speed is 100 Mbps, the first data pin P100 is set to logic “0”, and both of the second and third data pins P10, and P1000 are set to logic “1”. If the LAN speed is 10 Mbps, the second data pin P10 is set to logic “0”, and both of the first and third data pins P100, and P1000 are set to logic “1”. If the LAN speed is 1000 Mbps, the third data pin P1000 is set to logic “0”, and both of the first and second data pins P100, and P10 are set to logic “1”. The detecting microchip U further includes a control pin Ctrl to alternately output control signals, such as logic “1” or logic “0”.

The first NAND gate U1 includes two input pins I11, and I12, and an output pin O1. The input pin I11 is electronically connected to the first data pin P100, the input pin I12 is electronically connected to the second data pin P10, and the output pin O1 is electronically connected to the first AND gate U4.

The second NAND gate U2 includes two input pins I21, and I22, and an output pin O2. The input pin I21 is electronically connected to the second data pin P10, the input pin I22 is electronically connected to the third data pin P1000, and the output pin O2 is electronically connected to the second AND gate U5.

The NOT gate U3 includes an input pin I3 and an output pin O3. The input pin I3 is electronically connected to the control pin Ctrl, and the output pin Q3 is electronically connected to the first AND gate U4.

The first AND gate U4 includes two input pins I41, and I42, and an output pin O4. The input pin I41 is electronically connected to the output pin O1 of the first NAND gate U1, the input pin I42 is electronically connected to the output pin Q3 of the NOT gate U3, the output pin O4 is electronically connected to an anode of the first LED L1 and a cathode of the second LED L2 via the current-limiting resistor R4.

The second AND gate U5 includes two input pins I51, and I52, and an output pin O5. The input pin I51 is electronically connected to the output pin O2 of the second NAND gate U2, the input pin I52 is electronically connected to the control pin Ctrl, the output pin O5 is electronically connected to a cathode of the first LED L1 and an anode of the second LED L2 via the current-limiting resistor R5.

If the detecting microchip U detects the LNA speed of 100 Mbps, the first data pin P100 is set to logic “0”, both of the second and third data pins P10, and P1000 are set to logic “1”, and the control pin Ctrl alternately outputs logic “1” or logic “0”. Then, the output pin O1 of the first NAND gate U1 outputs logic “1”, and the output pin O2 of the second NAND gate U2 outputs logic “0”. When the control pin Ctrl outputs logic “1”, the output pin O4 of the first AND gate U4 outputs logic “0”, and the output pin O5 of the second AND gate U5 outputs logic “0”. Thus, both of the first LED L1 and the second LED L2 are turned off. When the control pin Ctrl outputs logic “0”, the output pin O4 of the first AND gate U4 outputs logic “1”, and the output pin O5 of the second AND gate U5 outputs logic “0”. Thus, the first LED L1 is turned on, and the second LED L2 is turned off. In this condition, the first LED L1 will twinkle or flash, and users can directly know the LAN speed is 100 Mbps.

If the detecting microchip U detects the LNA speed of 1000 Mbps, the third data pin P1000 is set to logic “0”, both of the first and second data pins P100, and P10 are set to logic “1”, and the control pin Ctrl alternately outputs logic “1” or logic “0”. Then, the output pin O1 of the first NAND gate U1 outputs logic “0”, and the output pin O2 of the second NAND gate U2 outputs logic “1”. When the control pin Ctrl outputs logic “0”, the output pin O4 of the first AND gate U4 outputs logic “0”, and the output pin O5 of the second AND gate U5 outputs logic “0”. Thus, both of the first LED L1 and the second LED L2 are turned off. When the control pin Ctrl outputs logic “1”, the output pin O4 of the first AND gate U4 outputs logic “0, and the output pin O5 of the second AND gate U5 outputs logic “1”. Thus, the second LED L2 is turned on, and the first LED L1 is turned off. In this condition, the second LED L2 will twinkle or flash, and users can directly know the LAN speed is 1000 Mbps.

If the detecting microchip U detects the LNA speed of 10 Mbps, the second data pin P10 is set to logic “0”, both of the first and third data pins P100, and P1000 are set to logic “1”, and the control pin Ctrl alternately outputs logic “1” or logic “0”. Then, the output pin O1 of the first NAND gate U1 outputs logic “1”, and the output pin O2 of the second NAND gate U2 outputs logic “1”. When the control pin Ctrl outputs logic “0”, the output pin O4 of the first AND gate U4 outputs logic “1”, and the output pin O5 of the second AND gate U5 outputs logic “0”. Thus, the first LED L1 is turned on, and the second LED L2 is turned off. When the control pin Ctrl outputs logic “1”, the output pin O4 of the first AND gate U4 outputs logic “0, and the output pin O5 of the second AND gate U5 outputs logic “1”. Thus, the second LED L2 is turned on, and the first LED L1 is turned off. In this condition, the first LED L1 and second LED L2 will alternately twinkle or flash, and users can directly know the LAN speed is 10 Mbps.

In summary, the detecting microchip U detects the LAN speed, and accordingly controls other logic components such as, the first NAND gate U1 to turn on/off the first LED L1 or/and the second LED L2. Thus, the first LED L1 twinkles or flashes to show the LAN speed is 100 Mbps, the second LED L2 twinkles or flashes to show the LAN speed is 1000 Mbps, the first LED L1 and the second LED L1 alternately twinkles or flashes to show the LAN speed is 10 Mbps. Since the indication circuit 100 can indicate three LAN speeds, it is both efficient and convenient.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. An indication circuit, comprising:
a network port configured to receive a network connector of a network cable, and comprising a first light-emitting diode (LED) L1 and a second LED L2;
a detecting microchip electronically connected to the network port to detect speed of a local area network (LAN) via the network cable, the detecting microchip comprising a first data pin, a second data pin, a third data pin, and a control pin, the detecting microchip configured to set the first data pin, the second data pin, and the third data pin according to the speed of the LAN, and the control pin outputting control signals;
a first NOT AND (NAND) gate comprising two input pins and an output pin, the two input pins respectively and electronically connected to the first data pin and the second data pin;
a second NAND gate comprising two input pins and an output pin, the two input pins of the second NAND gate respectively and electronically connected to the second data pin and the third data pin;
a NOT gate comprising an input pin and an output pin, the input pin of the NOT gate electronically connected to the control pin;
a first AND gate comprising two input pins and an output pin, the two input pins of the first AND gate respectively and electronically connected to the output pin of the first NAND gate and the output pin of the NOT gate, the output pin of the first AND gate electronically connected to an anode of the first LED and a cathode of the second LED; and
a second AND gate comprising two input pins and an output pin, the two input pins of the second AND gate respectively and electronically connected to the output pin of the second NAND gate and the control pin, the output pin of the second AND gate electronically connected to a cathode of the first LED and an anode of the second LED.

2. The indication circuit as claimed in claim 1, further comprising three pull-up resistors, the first data pin, the second data pin, and the third data pin are electronically connected to a power supply via one of the three pull-up resistors, respectively.

3. The indication circuit as claimed in claim 1, further comprising two current-limiting resistors, the output pin of the first AND gate electronically connected to an anode of the first LED and a cathode of the second LED via one of the two current-limiting resistors; and the output pin of the second AND gate electronically connected to a cathode of the first LED and an anode of the second LED via another current-limiting resistor.

4. The indication circuit as claimed in claim 1, wherein if the LAN speed is a first speed, the first data pin is set to logic “0”, and both of the second and third data pins are set to logic “1”.

5. The indication circuit as claimed in claim 4, wherein when the control signal output from the control pin is logic “1”, both of the first LED and the second LED are turned off; when the control signal is logic “0”, the first LED is turned on, and the second LED is turned off.

6. The indication circuit as claimed in claim 1, wherein if the LAN speed is a second speed, the third data pin is set to logic “0”, and both of the first and second data pins are set to logic “1”.

7. The indication circuit as claimed in claim 6, wherein when the control signal output from the control pin is logic “1”, both of the first LED and the second LED are turned off; when the control signal is logic “0”, the second LED is turned on, and the first LED is turned off.

8. The indication circuit as claimed in claim 1, wherein if the LAN speed is a second speed, the second data pin is set to logic “0”, and both of the first and third data pins are set to logic “1”.

9. The indication circuit as claimed in claim 5, wherein when the control signal output from the control pin is logic “0”, the first LED is turned on, and the second LED is turned off; when the control signal is logic “1”, the second LED is turned on, and the first LED is turned off.
